(19) United States
(12) Patent Application Publication
(10) Pub. No.: US 2012/0243933 A1
(43) Pub. Date: Sep. 27, 2012

(54) BUTT JOINT BETWEEN ENDS OF SEALING STRIPS OR OF A SEALING STRIP

(75) Inventors: Bernd Raesch, Wadern (DE); Jan Bardac, Raztocno (SK)

(73) Assignee: SAARGUMMI TECHNOLOGIES S.À.R.L., Schengen (LU)

(21) Appl. No.: 13/515,573

(22) PCT Filed: Dec. 10, 2010
(86) PCT No.: PCT/EP10/07549

§ 371 Date: Jun. 13, 2012

(30) Foreign Application Priority Data
Dec. 14, 2009 (DE) 10 2009 058 057.3
Dec. 23, 2009 (DE) 10 2009 060 151.1

(51) Int. Cl. F16B 13/02

(52) U.S. Cl. 403/298

(57) ABSTRACT

A butt joint between ends of sealing strips or a sealing strip, comprises a connecting piece for engaging into cavities in the sealing strips or in the sealing strip, the chambers being open at the front face thereof. The connecting piece has devices for hooking onto the walls of the hollow chambers.

The invention relates to a butt joint between ends of sealing strips or of a sealing strip, having a connection piece for engagement in cavities in the sealing strips or sealing strip, which are open on the face side. The butt joint particularly relates to sealing strips used for sealing of gaps on vehicle bodies.

Such a butt joint between sealing strip ends is known, for example, from DE 10 2004 021 934 A1. The connection piece of this known butt joint engages into the cavities in the sealing strips that are open toward the butt location, with force fit.

The invention is based on the task of creating a new butt joint between sealing strip ends, of the type mentioned initially, which joint is improved in terms of its stability.

The butt joint that accomplishes this task, according to the invention, is characterized in that the connection piece has at least one device for hook engagement with a wall of one of the cavities.

It is advantageous if the connection piece is fixed in place within the cavity or cavities in question, in the longitudinal strip direction, by means of the hook engagement according to the invention, and if the butt joint is thereby stabilized. The butt joint can be produced in simple manner just before installation, so that ring seals can advantageously be supplied as an open strip, if necessary with a connection piece affixed unilaterally.

In the case of unilateral affixation of the connection piece on the open strip, in particular, the connection piece can be glued or welded on, alternatively or in addition to hook engagement with the cavity wall in question.

In a preferred embodiment of the invention, the hook engagement device comprises a hook engagement stud that projects from the connection piece, perpendicular to the longitudinal axis of the sealing strips, for engagement into a bore in the cavity wall.

Alternatively or in addition, the hook engagement device can comprise teeth inclined counter to the advancing direction of the connection piece, which teeth press into the soft elastomer material of the sealing strip.

It is practical if the stud has a slanted or rounded part that drops in the advancing direction of the connection pieces, which part facilitates insertion of the connection piece into the face-side opening.

In a further embodiment of the invention, the connection piece has a stop piece that delimits the advance into the cavities. The stop piece can be disposed in such a manner that in the stop position, the stud in question is oriented precisely with regard to the bore that accommodates the stud. Depending on the width of the stop piece, a gap occurs at the butt location, which gap can be utilized for water removal, for example in the case of a ring seal for a vehicle door that is formed by means of the butt joint.

In an embodiment of the invention, the sealing strips have or the sealing strip has an attachment section and a sealing section that preferably consists of a softer material than the attachment section, whereby the cavities are formed, in each instance, by means of a longitudinal channel in the attachment section.

The bores that accommodate a hook engagement stud can be provided on opposite sides or only on one side of the longitudinal channel. In particular, bores that each accommodate one hook engagement stud are formed on that side of the longitudinal channel that faces away from or toward an attachment surface of the attachment section.

In a further embodiment of the invention, the sealing strips or the sealing strip are provided for attachment to a seal seat, using plastic clips. It is advantageous if the bores that accommodate the plastic clips have the same diameter as the bores that accommodate the hook engagement studs. It is advantageous that the same drilling tool can be used to produce both types of bores.

In the following, the invention will be explained in further detail using exemplary embodiments and the attached drawings that relate to these exemplary embodiments. These show:

FIG. 1 a butt joint according to the invention, in a perspective view,

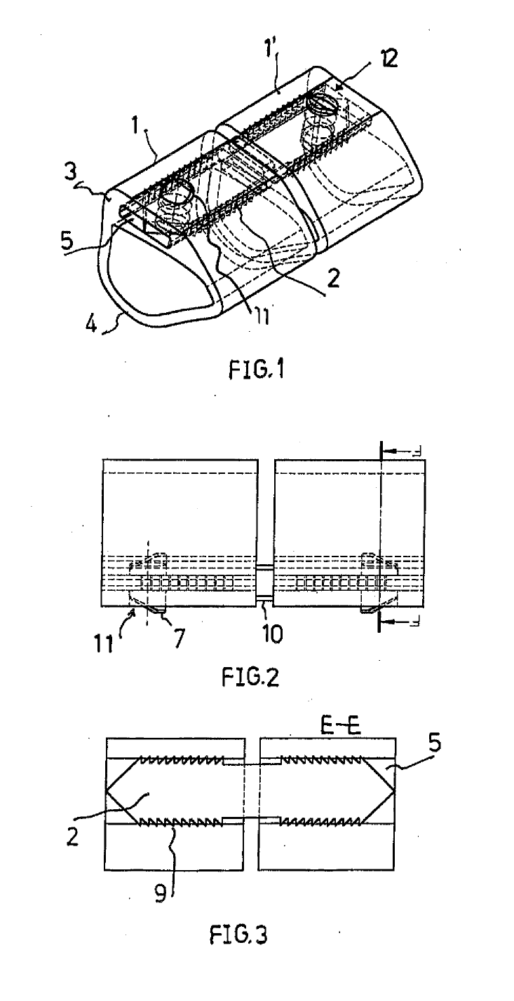

FIGS. 2 and 3 the butt joint in side views that are rotated by 90° relative to one another, partly in section,

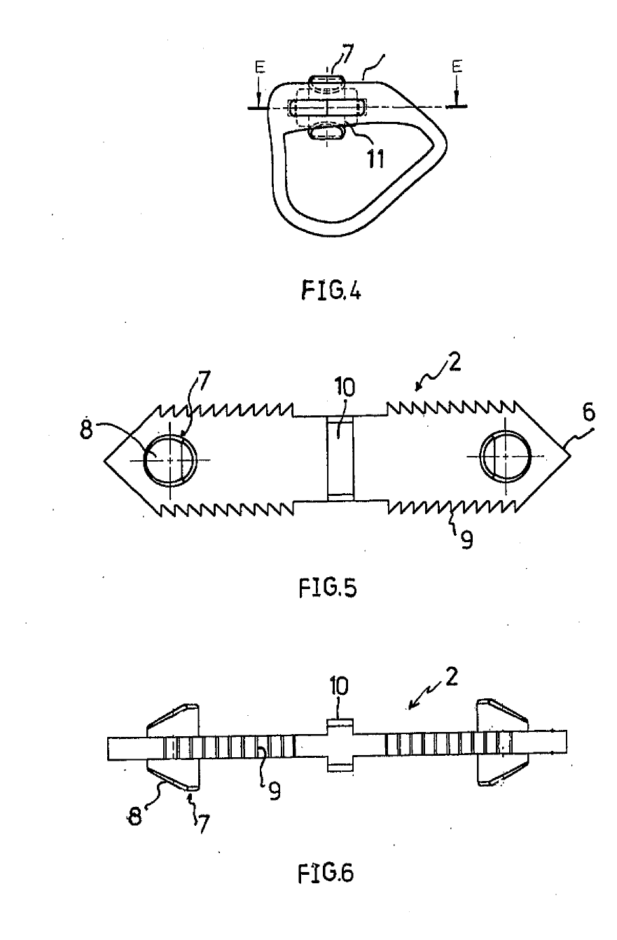

FIG. 4 a cross-sectional view of the butt joint of FIG. 1,

FIGS. 5 and 6 a connection piece used in the butt joint of FIGS. 1 to 4, in views rotated by 90° relative to one another,

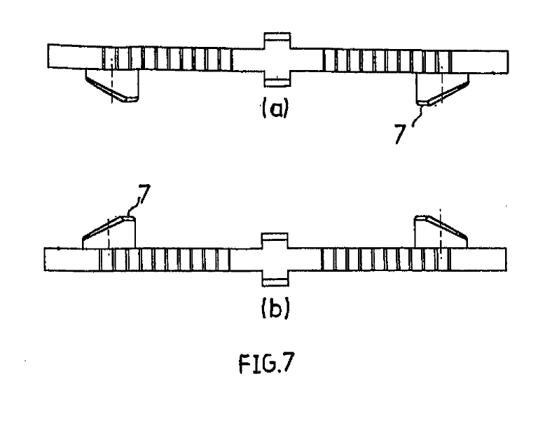

FIG. 7 other exemplary embodiments of connection pieces of a butt joint according to the invention.

End sections of two sealing strips 1 and 1′ or of a single sealing strip, connected at the ends to form a ring, are connected with one another by way of a connection piece 2 shown separately in FIGS. 5 and 6. The sealing strips or the sealing strip furthermore have/has an attachment section 3, in each instance, with an attachment surface 12 that can be laid against a seal seat, and a sealing section 4 that is tubular in this exemplary embodiment. A flat longitudinal channel 5 in the attachment section 3 forms a cavity that is open on the face side, in each instance, into which cavity the connection piece 2 engages.

As is evident from FIGS. 5 and 6, the connection piece 2 is configured as a flat body, corresponding to the flat longitudinal channel 5, which body has a point 6 at both longitudinal ends, in the example shown.

Close to the pointed ends, studs 7 facing in opposite directions project from broad sides of the connection piece 2 that lie opposite one another, in each instance, which studs have a bevel 8 that drops toward the pointed end, in each instance.

Teeth 9 on opposite narrow sides of the connection piece 2 incline away from the nearest point 6, in each instance.

In the center of the connection piece 2, stop pieces 10 facing in opposite directions project from the broad sides, which pieces delimit the penetration of the connection piece into the longitudinal channels 5 of the sealing strips 1, 1′ that lie opposite one another with their face sides. In place of the two stop pieces 10, only a single stop piece could also be formed.

For the production of the butt joint shown in FIGS. 1 to 4, the connection piece 2 is introduced into the related longitudinal channel 5 in the sealing strips 1 and 1′, with its longitudinal ends first. The points 6 simplify this process. The bevels 8, which allow problem-free widening of the longitudinal channel, facilitate further advance into the longitudinal channel 5. During advancing of the connection piece 2 until it comes to a stop against the stop pieces 10, the studs 7 get into a bore 11 that passes through the attachment section 3 of the sealing strips, in each instance. As a result, the connection piece 2 is firmly interlocked into the longitudinal channels 5 of the sealing strips 1, 1′. The teeth 9, which are inclined counter to the advancing direction, contribute to further hook engagement.

The stop pieces 10 can be narrower or also wider than in the exemplary embodiment shown, or they can also be eliminated entirely.

In the exemplary embodiment shown, the drilling tool used for production of the bores 11 is furthermore used to make bores distributed over the length of the sealing strip, in the attachment section 3, for accommodating plastic clips that are used to attach the sealing strip on a seal seat. Accordingly, the bores 11 have the same diameter as the aforementioned bores for the studs (not shown).

FIGS. 7a and 7b show connection pieces that have hook engagement studs 7 only on one side, in each instance. The hook engagement studs 7 of the connection piece of FIG. 7a engages into bores that lie on the side of the longitudinal channel 5 that faces the attachment surface 12, while the hook engagement studs 7 of the connection piece of FIG. 7b engage into bores on the other side of the longitudinal channel 5. It is advantageous that in the latter case, the hook engagement studs 7 cannot impair the paint surface of the seal seat.

1. Butt joint between ends (1, 1′) of sealing strips or of a sealing strip, having a connection piece (2) for engagement in cavities (5) in the sealing strips (1, 1′) or the sealing strip, which are open on the face side, wherein
the connection piece (2) has at least one device (7, 9) for hook engagement with a wall of one of the cavities (5).

2. Butt joint according to claim 1,
wherein
the hook engagement device comprises a hook engagement stud (7) for engagement into a bore (11) in the cavity wall, which stud projects from the connection piece (2) perpendicular to the longitudinal axis of the sealing strips (1, 1′).

3. Butt joint according to claim 1, wherein
the hook engagement device comprises teeth (9) inclined counter to the advancing direction of the connection piece (2).

4. Butt joint according to claim 2, wherein
the hook engagement stud (7) has a bevel (8) that drops in the advancing direction of the connection piece (2).

5. Butt joint according to claim 1, wherein
the connection piece (2) has a stop piece (10) that limits the advancing depth into the cavities (5).

6. Butt joint according to claim 1, wherein
the sealing strips (1, 1′) or the sealing strip have/has an attachment section (3) and a sealing section (4) that preferably consists of a softer material than the attachment section (3), and that the cavities are formed in the attachment section (3), in each instance, by means of a longitudinal channel (5).

7. Butt joint according to claim wherein
bores (11) that each accommodate one hook engagement stud (7) are provided on opposite sides or only on one side of the longitudinal channel (5).

8. Butt joint according to claim 7, wherein
bores (11) that each accommodate one hook engagement stud (7) lie on that side of the longitudinal channel (5) that faces toward or away from an attachment surface (12) of the attachment section (3).

9. Butt joint according to claim 6, wherein
the cavities are configured as flat longitudinal channels (5), parallel to an attachment surface (12) of the attachment section (3), in cross-section.

10. Butt joint according to claim 1, wherein
the sealing strips (1, 1′) or the sealing strip are/is provided for attachment to a seal seat using plastic clips.

11. Butt joint according to claim 10, wherein
bores provided in the attachment section for the plastic clips have the same bore diameter as the bores (11) for accommodating the hook engagement studs (7).

12. Butt joint according to claim 1, wherein
the connection piece (2) is glued or/and welded to the cavity wall in at least one of the cavities (5).
